(19) United States
(12) Patent Application Publication
(10) Pub. No.: US 2014/0076183 A1
(43) Pub. Date: Mar. 20, 2014

(54) WEB MATERIALS COMPRISING BROWN INK

(71) Applicant: The Procter & Gamble Company, Cincinnati, OH (US)

(72) Inventors: David Mark RASCH, Cincinnati, OH (US); Cathy Marie SANDERS, Cleves, OH (US)

(73) Assignee: The Procter & Gamble Company, Cincinnati, OH (US)

(21) Appl. No.: 14/089,034

(22) Filed: Nov. 25, 2013

Related U.S. Application Data
(63) Continuation of application No. 12/545,427, filed on Aug. 21, 2009.

(51) Int. Cl. B41F 5/24

(52) U.S. Cl. CPC B41F 5/24
USPC 101/483

(57) ABSTRACT

Web materials having brown ink in their print images and methods for making same are provided.

### FIELD OF THE INVENTION

The present invention relates to web materials comprising brown ink and more particularly to sanitary tissue products comprising brown ink and methods for making same.

### BACKGROUND OF THE INVENTION

Web materials, such as fibrous structures comprising ink are well known in the art. Various web materials, such as sanitary tissue products, especially paper towels and napkins, have employed various colored inks to impart print images onto the web materials.

In the past, formulators have used a limited number of ink colors to create print images on web materials, especially on sanitary tissue products. For example, formulators have used yellow, magenta, cyan and black inks to create print images on web materials. Formulators have been forced to try to create a brown print image by applying 3 or 4 ink colors (yellow, magenta, cyan and black) to a web material. It has been found that these four ink colors fail to produce a consumer acceptable brown print image on web materials, such as sanitary tissue products. It has been found that these standard four ink colors (cyan, magenta, yellow, and black) have failed to produce a consistent brown print image on web materials over time based on typical variation of each colored ink combined with typical variation in print plate wear resulting in a multitude of shades of brown varying from the desired target.

In the past, formulators printing images on web materials have settled for a high level of shade variation in brown since it produced acceptable print quality when the print plates were new and the inks were at target even though the results in long term production were not as good thus requiring quality standards regarding how much shade variation from target was acceptable.

In addition to the problems discussed above, brown ink itself also presents problems to using it in print images on web materials. Brown ink is a combination of pigments requiring relatively higher pigment levels in the ink formulation than other colored ink formulations. This high pigment levels unfortunately increases the ability of the brown ink to rub-off in use, which is a significant consumer negative.

Accordingly, there is a need for a brown ink that can be used to create consumer acceptable brown print images on web materials, such as sanitary tissue products.

### SUMMARY OF THE INVENTION

The present invention fulfills the need described above by providing a web material, for example a fibrous structure and/or sanitary tissue product comprising a fibrous structure that comprises a brown ink.

In one example of the present invention, a web material comprising a brown ink is provided.

In another example of the present invention, a method for making a web material, the method comprising the steps of:

a. providing a web material, such as web material; and

b. contacting the web material with a brown ink, is provided.

The present invention provides web materials comprising brown ink and a method for making web materials comprising brown ink.

### BRIEF DESCRIPTION OF THE DRAWINGS

FIG. 1 is an illustration of the Commission Internationale de l'Eclairage L*a*b* color space (CIELab);

FIG. 2 is a schematic representation of an example of a web material according to the present invention;

FIG. 3 is schematic representation of an example of a printing process according to the present invention;

FIG. 4 is a schematic representation of an example of a printing process according to the present invention;

FIG. 5 is a schematic representation of another example of a printing process according to the present invention; and

FIG. 6 is an exploded schematic representation of a portion of the printing process of FIG. 5.

### DETAILED DESCRIPTION OF THE INVENTION

### Definitions

“Brown ink” as used herein means an ink that exhibits an L*a*b* as follows: L* of from about 10 to about 70, a* of from about 5 to about 20 and b* of from about 10 to about 30. In one example, the brown ink exhibits an L*a*b* of 30, 8, 14 to 64, 15, 21. In another example, the brown ink exhibits an L*a*b* of 44.82, 10.86, 18.18. In still another example, the brown ink exhibits an L*a*b* of 32, 9, 15 to 62, 14, 21. In still yet another example, the brown ink exhibits an L*a*b* of 48, 10, 21 to 78, 15.50, 28. In even still yet another example, the brown ink exhibits an L*a*b* of 58.07, 12.57, 24.98. In even still yet another example, the brown ink exhibits an L*a*b* of 48, 17, 37. The brown ink may exhibit a hue of from about 55 to about 85.

“Lab Color” or “L*a*b*,” as used herein, refers to a color model that is used by those of skill in the art to characterize and quantitatively describe perceived colors with a relatively high level of precision. More specifically, CIELab may be used to illustrate a gamut of color because L*a*b* color space has a relatively high degree of perceptual uniformity between colors. As a result, L*a*b* color space may be used to describe the gamut of colors that an ordinary observer may actually perceive visually.

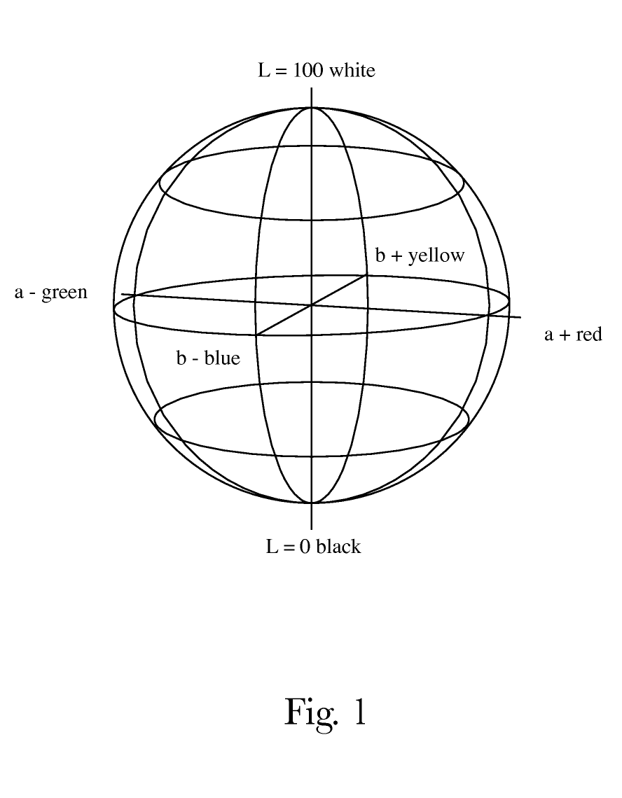

Referring to FIG. 1, a color's identification is determined according to the Commission Internationale de l'Eclairage L*a*b* color space (hereinafter “CIELab”). CIELab is a mathematical tristimulus color scale based on the CIE 1976 standard. CIELab allows colors to be described quantitatively and with precision. As presented in FIG. 1, CIELab allows a color to be plotted in a three-dimensional space analogous to the Cartesian xyz space. CIELab has the colors green to red on what is traditionally the x-axis in Cartesian xyz space. CIELab identifies this axis as the a-axis. A negative a* value represents green and a positive a* value represents red. CIELab has the colors blue to yellow on what is traditionally the y-axis in Cartesian xyz space. CIELab identifies this axis as the b-axis. Negative b* values represent blue and positive b* values represent yellow. CIELab has lightness on what is traditionally the z-axis in Cartesian xyz space. CIELab identifies this axis as the L-axis. The L*-axis ranges in value from 100, which is white, to 0, which is black. An L* value of 50 represents a mid-tone gray (provided that a* and b* are 0). Any color may be plotted in CIELab according to the three values (L*, a*, b*).

The three dimensional CIELab allows the three color components of chroma, hue, and lightness to be calculated. Within the two-dimensional space formed from the a-axis and b-axis, the components of hue and chroma can be determined. Chroma is the relative saturation of the perceived color and is determined by the distance from the origin as measured in the a*b* plane. Chroma, for a particular (a*, b*) set is calculated according to Formula 1 as follows:

C*=(a*²+b*²)^{1/2} Formula 1

For example, a color with a*b* values of (10,0) would exhibit a lesser chroma than a color with a*b* values of (20,0). The latter color would be perceived qualitatively as being more red than the former. Hue is the relative red, yellow, green, and blue in a particular color. A ray can be created from the origin to any color within the two-dimensional a*b* space. Hue is the angle measured from 0° (the positive a* axis) to the created ray. Hue can be any value of between 0° to 360°. Lightness is determined from the L* value with higher values being more white and lower values being more black.

“Process Printing,” as used herein, refers to a method of providing print images on a web material using primary colored inks and/or dyes. For purposes of the present invention the word “ink” or “inks” will be used to represent both inks and dyes. Known process printing utilizes the colors cyan (“C”), magenta (“M”), yellow (“Y”) and black (“K”). Process printing applies one or more layers of colors onto a web material to create a print image. With the addition of each layer of color, certain amounts of light are absorbed (those of skill in the printing arts will understand that the inks actually “subtract” from the brightness of a white background), resulting in various colors. The colors cyan, magenta and yellow (“CMY”) may be used in combination to provide additional colors. Non-limiting examples of such colors are red, green, and blue. Black (“K”) may be used to provide alternate shades and pigments. One of skill in the art will appreciate that CMY may alternatively be used in combination to provide a black-type color.

It has surprisingly been found that a brown ink may be used in process printing in conjunction with other colored inks to create print images. In the past, the color brown in print images on web materials was only achievable by combining various non-brown inks As may be expected, the resulting brown color in the print image from combining various non-brown inks (for example CMY) exhibited negatives with consumers of the web materials. The present invention overcomes those negatives by employing a brown ink in process printing to create print images on web materials that comprise the color brown. A process printing system according to the present invention utilizes brown ink and optionally, one or more additional colored inks, such as cyan (“C”), magenta (“M”) and (“yellow”).

“Halftoning,” as used herein, sometimes known to those skilled in the printing arts as “screening,” is a printing technique that allows for less-than-full saturation of the colors. In halftoning, relatively small dots of each color are printed in a pattern small enough such that the average human observer perceives a single color. For example, magenta printed with a 20% halftone will appear to the average observer as the color pink. The reason for this is because, without wishing to be limited by theory, the average observer may perceive the tiny magenta dots and white paper between the dots as lighter, and less saturated, than the color of pure magenta ink.

“Base Color,” as used herein, refers to a color that is used in the halftoning printing process as the foundation for creating additional colors. A base color may be provided by a colored ink. Non-limiting examples of base colors may be selected from the group consisting of: cyan, magenta, yellow, black, red, green, blue-violet, and brown. It has been found that brown ink, in combination with other colored inks, may be used to achieve the color black in print images on web materials. For example, brown ink and cyan ink may produce the color black in print images on web materials.

“Resultant Color,” as used herein, refers to the color that an ordinary observer perceives on a web material of a halftone printing process. For example, the resultant color of magenta ink printed at a 20% halftone is pink.

“Web material” as used herein means a fibrous structure, a sanitary tissue product comprising a fibrous structure, and/or flexible packaging such as a packaging films and/or cardboard cartons. The film may comprise a polymeric film, such as a plastic film.

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products).

Non-limiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

The fibrous structures may be embossed.

The fibrous structure may comprise a binder, such as a latex. In one example, the binder comprises ethylene vinyl acetate.

The fibrous structures of the present invention may be co-formed fibrous structures.

“Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a fiber and/or a particulate. In one example, a co-formed fibrous structure comprises solid additives, such as fibers, such as wood pulp fibers, and filaments, such as polypropylene filaments.

“Solid additive” as used herein means a fiber and/or a particulate.

“Particulate” as used herein means a granular substance or powder.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm and a “filament” is an elongate particulate as described above that exhibits a length of greater than or equal to 5.08 cm.

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Sanitary tissue product” as used herein means a soft, low density (i.e. <about 0.15 g/cm3) web useful as a wiping implement for post-urinary and post-bowel movement cleaning (toilet tissue), for otorhinolaryngological discharges (facial tissue), multi-functional absorbent and cleaning uses (absorbent towels), and napkins The sanitary tissue product may be convolutedly wound upon itself about a core or without a core to form a sanitary tissue product roll.

In one example, the sanitary tissue product of the present invention comprises a fibrous structure according to the present invention.

The sanitary tissue products and/or fibrous structures of the present invention may exhibit a basis weight of greater than 15 g/m² to about 120 g/m² and/or from about 15 g/m² to about 110 g/m² and/or from about 20 g/m² to about 100 g/m² and/or from about 30 g/m² to about 90 g/m². In addition, the sanitary tissue products and/or fibrous structures of the present invention may exhibit a basis weight between about 40 g/m² to about 120 g/m² and/or from about 50 g/m² to about 110 g/m² and/or from about 55 g/m² to about 105 g/m² and/or from about 60 g/m² to 100 g/m².

The sanitary tissue products of the present invention may exhibit an initial total wet tensile strength of less than about 78 g/cm and/or less than about 59 g/cm and/or less than about 39 g/cm and/or less than about 29 g/cm.

The sanitary tissue products of the present invention may exhibit an initial total wet tensile strength of greater than about 118 g/cm and/or greater than about 157 g/cm and/or greater than about 196 g/cm and/or greater than about 236 g/cm and/or greater than about 276 g/cm and/or greater than about 315 g/cm and/or greater than about 354 g/cm and/or greater than about 394 g/cm and/or from about 118 g/cm to about 1968 g/cm and/or from about 157 g/cm to about 1181 g/cm and/or from about 196 g/cm to about 984 g/cm and/or from about 196 g/cm to about 787 g/cm and/or from about 196 g/cm to about 591 g/cm.

The sanitary tissue products of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets. Alternatively, the sanitary tissue products of the present invention may be in the form of discrete sheets, such as a stack of facial tissues.

The sanitary tissue products of the present invention may comprises additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Machine Direction” or “MD” as used herein means the direction parallel to the flow of the web material through the web material making machine and/or printing process.

“Cross Machine Direction” or “CD” as used herein means the direction parallel to the width of the web material making machine.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

### Web Materials

Various web materials comprising ink are known in the art. Printing of images on web materials, for example sanitary tissue products may be performed by applying numerous colored ink dots onto a surface of the web material. This process is referred to a “halftoning.” In conventional printing processes, the colored ink dots are yellow, magenta, cyan and black. The printed images on web materials can be made up of different ink colors that are applied to the surfaces of the web materials.

In one example of the present invention, as shown in FIG. 2, a web material 10, for example a fibrous structure and/or a sanitary tissue product, according to the present invention, comprises brown ink, for example in the form of brown ink dots 12. The brown ink dots 12 may be of any geometric shape and may be present at any suitable level known in the art. In one example, the brown ink dots have a generally circular shape. In addition to the brown ink dots 12, the L*a*b* of which can be measured by the Color Test Method described herein, other colored ink, for example in the form of non-brown colored ink dots 14, may be present on the web material 10. The brown ink dots 12 may be present on a surface of the web material 10. Further, the brown ink dots 12 may form part of a print image on the web material 10.

In another example, a web material, for example a sanitary tissue product according to the present invention, comprises brown ink that exhibits an L*a*b* of 30, 8, 14 to 64, 15, 21.

In another example, a web material, for example a sanitary tissue product according to the present invention, comprises brown ink that exhibits an L*a*b* of 44.82, 10.86, 18.18.

In still another example, a web material, for example a sanitary tissue product, according to the present invention, comprises brown ink that exhibits an L*a*b* of 32, 9, 15 to 62, 14, 21.

In even yet another example, a web material, for example a sanitary tissue product according to the present invention, comprises brown ink that exhibits an L*a*b* of 42.57, 11.54, 18.03.

By utilizing brown ink to create print images on web materials, less total ink is used compared to printing processes that do not use brown ink since the color brown within the print image does not need to be created by combining numerous colored inks In addition, by utilizing brown ink, the number of ink stations can be reduced since the color brown in a print image is not created by combining numerous colored inks from numerous ink stations.

In addition to brown ink, the web material of the present invention may comprise other colors of ink, non-brown inks For example, sanitary tissue products may comprise yellow, magenta, cyan and/or black ink dots.

In one example, the web material of the present invention comprises a sanitary tissue product. In another example, the web material of the present invention comprises a napkin. Still in another example, the web material comprises a paper towel.

In yet another example, the web material comprises a packaging film.

In even yet another example, the web material comprises cardboard and/or paperboard.

The composition of the ink may be any suitable ink composition that is known in the art so long as it exhibits the desired color.

Any suitable printing process known in the art for imparting print images to a web material may be used to impart print images to a web material according to the present invention.

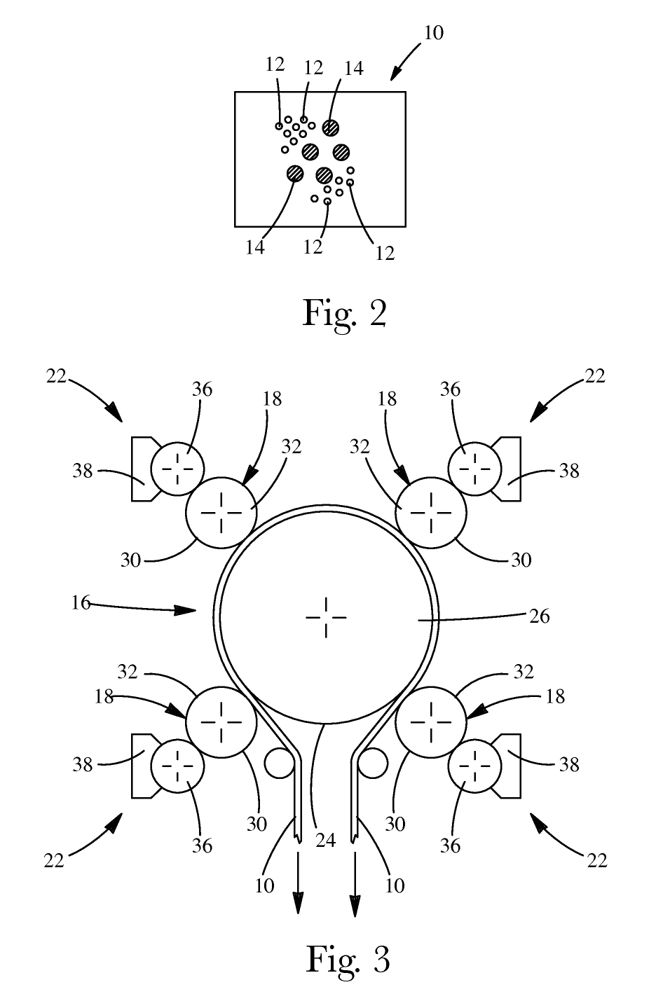

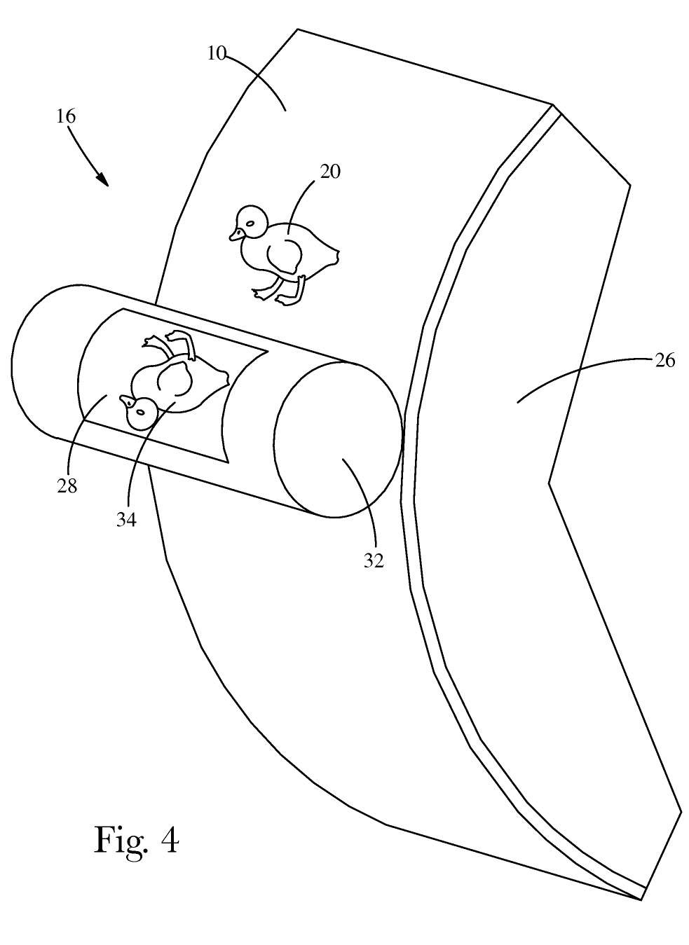

In one example, the printing process comprises a flexographic printing process. A non-limiting example of a suitable flexographic printing process 16 is shown in FIGS. 3 and 4. A web material 10 is fed into a printing machine 18 and an image 20 is printed on the web material 10 as the web material 10 is advanced through a plurality of print units 22 disposed about an outer surface 24 of a central impression cylinder 26. Each print unit 22 may include a print plate 28 connected with an outer surface 30 of a print cylinder 32. The print plate 28 may include graphic images 34 of the graphics to be printed. The print unit 22 may also include an anilox roll 36, which applies ink from an ink pan 38 to the print plate 28. During the printing process, the central impression cylinder 26, the print cylinder 32, and anilox roll 36 all rotate, and the print plate 28 contacts the web material 10 to transfer the ink from the graphic images 34 on the print plate 28 to the web material 10 thereby printing the images 20 thereon. Each print unit 22 may apply a different color of ink such as yellow, magenta, cyan and brown. In one example of the present invention, at least one print unit 22 applies a brown ink to the web material 10.

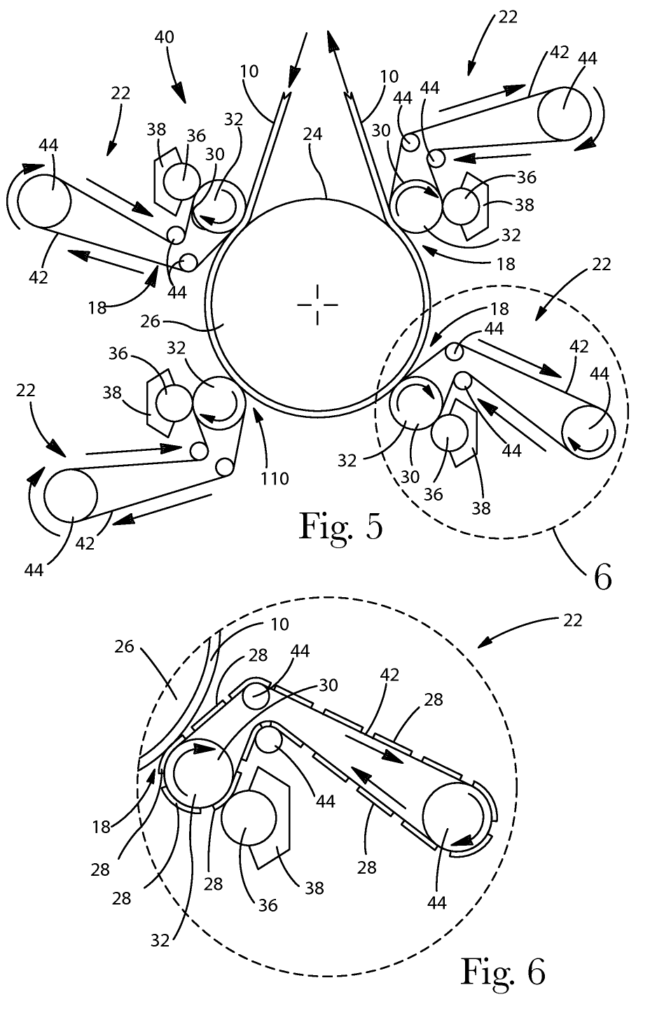

In another example of a suitable printing process 40 as shown in FIGS. 5 and 6, a web material 10 is fed into a printing machine 18 and one or more images 20 are printed on the web material 10 as the web material 10 is advanced through a plurality of print units 22 disposed about an outer surface 24 of a central impression cylinder 26. Each print unit 22 may comprise one or more print plates 28 disposed on a belt 42. The belt 42 may be supported on various support rolls 44. The arrows represent the direction of travel of the web material 10 and/or belt 42. Each print plate 28 is adapted to print a plurality of graphics on the web material 10. The print units 22 may also be configured for halftone printing and configured to print different colors. The print plates 28 are connected with an outer surface 30 of a print cylinder 32. The print plate 28 may include graphic images (not shown) of the graphics to be printed. The print unit 22 may also include an anilox roll 36, which applies ink from an ink pan 38 to the print plate 28. During the printing process, the central impression cylinder 26, the print cylinder 32, and anilox roll 36 all rotate, and the print plate 28 contacts the web material 10 to transfer the ink from the graphic images (not shown) on the print plate 28 to the web material 10 thereby printing the images (not shown) thereon. Each print unit 22 may apply a different color of ink such as yellow, magenta, cyan and brown. In one example of the present invention, at least one print unit 22 applies a brown ink to the web material 10.

In one example, the ink that is transferred by the printing processes is transferred from each print unit to the web material in a non-random arrangement of dots that combine to form an image on the web material, such as a fibrous structure and/or sanitary tissue product. The ink dots may be of various shapes and sizes, e.g. circular, square, hexagon, elliptical, etc.

### Inks

A non-limiting example of a brown ink of the present invention is commercially available from Sun Chemical, Parsippany, N.J.

In one example, the brown ink present on the web material exhibits an intensity of greater than 0.27 and/or greater than 0.35 and/or greater than 0.45 and/or greater than 0.5 and/or greater than 0.6 as measured according to the Color Intensity Test Method described herein.

In one example, the brown ink present on the web material exhibits a rub-off value when tested with the standard solution of less than 9 (solution) and/or less than 6 and/or less than 4 to about 0 and/or to about 1 as measured according to the Rub-Off Test Method described herein. In another example, the brown ink present on the web material exhibits a rub-off value when tested with distilled water of less than 11 and/or less than 9 and/or less than 7 to about 0 and/or to about 1 and/or to about 2 as measured according to the Rub-Off Test Method described herein.

In one example, the brown ink may comprise a rub-off agent that reduces the rub-off value of the brown ink as compared to a brown ink void of such a rub-off agent. Non-limiting examples of suitable rub-off agents include waxes and glycerin. A non-limiting example of a suitable wax includes a polyethylene wax emulsion, such as JONWAX 25, which is commercially available from S.C. Johnson & Sons, Inc, Racine, Wis.. Addition of a suitable wax to the brown ink may enhance rub-off resistance by setting up a barrier which inhibits the physical disruption of the ink after application of the ink to a web material. The wax may be present in the brown ink at a level of from about 0.1% to about 10% solids and/or from about 0.5% to about 10% solids and/or from about 0.5% to about 8% solids. The glycerin may be present in the brown ink at a level of from about 0.1% to about 20% solids and/or from about 0.5% to about 20% solids and/or from about 3% to about 15% solids and/or from about 8% to about 13% solids.

### Test Methods

Unless otherwise specified, all tests described herein including those described under the Definitions section and the following test methods are conducted on samples that have been conditioned in a conditioned room at a temperature of 73° F.±4° F. (about 23° C.±2.2° C.) and a relative humidity of 50%±10% for 2 hours prior to the test. All plastic and paper board packaging materials must be carefully removed from the paper samples prior to testing. Discard any damaged product. All tests are conducted in such conditioned room.

### Basis Weight Test Method

Basis weight of a fibrous structure and/or sanitary tissue product sample is measured by selecting twelve (12) usable units (also referred to as sheets) of the fibrous structure and/or sanitary tissue product and making two stacks of six (6) usable units each. Perforation must be aligned on the same side when stacking the usable units. A precision cutter is used to cut each stack into exactly 8.89 cm×8.89 cm (3.5 in.×3.5 in.) squares. The two stacks of cut squares are combined to make a basis weight pad of twelve (12) squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$${Basis Weight}_{( lbs / 3000 {ft}^{2} )} = \frac{Weight of basis weight pad ( g ) \times 3000 {ft}^{2}}{\begin{matrix}453.6 g \text{/} lbs \times 12 ( usable units ) \times [ 12.25 \\ {in}^{2} ( Area of basis weight pad ) \text{/} 144 {in}^{2} ]\end{matrix} }$$

$${Basis Weight}_{( g / {m}^{2} )} = \frac{Weight of basis weight pad ( g ) \times 10 , 000 {cm}^{2} / {m}^{2}}{79.0321 {cm}^{2} ( Area of basis weight pad ) \times 12 ( usable units )}$$

### Absorbency Test Method (Horizontal Full Sheet (HFS)):

The Horizontal Full Sheet (HFS) test method determines the amount of distilled water absorbed and retained by a sanitary tissue product of the present invention. This method is performed by first weighing a sample of the sanitary tissue product to be tested (referred to herein as the “Dry Weight of the paper”), then thoroughly wetting the sanitary tissue product, draining the wetted sanitary tissue product in a horizontal position and then reweighing (referred to herein as “Wet Weight of the paper”). The absorptive capacity of the sanitary tissue product is then computed as the amount of water retained in units of grams of water absorbed by the sanitary tissue product. When evaluating different sanitary tissue product samples, the same size of sanitary tissue product is used for all samples tested.

The apparatus for determining the HFS capacity of sanitary tissue product comprises the following: an electronic balance with a sensitivity of at least ±0.01 grams and a minimum capacity of 1200 grams. The balance should be positioned on a balance table and slab to minimize the vibration effects of floor/benchtop weighing. The balance should also have a special balance pan to be able to handle the size of the sanitary tissue product tested (i.e.; a paper sample of about 11 in. (27.9 cm) by 11 in. (27.9 cm)). The balance pan can be made out of a variety of materials. Plexiglass is a common material used.

A sample support rack and sample support cover is also required. Both the rack and cover are comprised of a lightweight metal frame, strung with 0.012 in. (0.305 cm) diameter monofilament so as to form a grid of 0.5 inch squares (1.27 cm²). The size of the support rack and cover is such that the sample size can be conveniently placed between the two.

The HFS test is performed in an environment maintained at 23±1° C. and 50±2% relative humidity. A water reservoir or tub is filled with distilled water at 23±1° C. to a depth of 3 inches (7.6 cm).

The sanitary tissue product to be tested is carefully weighed on the balance to the nearest 0.01 grams. The dry weight of the sample is reported to the nearest 0.01 grams. The empty sample support rack is placed on the balance with the special balance pan described above. The balance is then zeroed (tared). The sample is carefully placed on the sample support rack. The support rack cover is placed on top of the support rack. The sample (now sandwiched between the rack and cover) is submerged in the water reservoir. After the sample has been submerged for 60 seconds, the sample support rack and cover are gently raised out of the reservoir.

The sample, support rack and cover are allowed to drain horizontally for 120±5 seconds, taking care not to excessively shake or vibrate the sample. Next, the rack cover is carefully removed and the wet sample and the support rack are weighed on the previously tared balance. The weight is recorded to the nearest 0.01 g. This is the wet weight of the sample.

The gram per sanitary tissue product sample absorptive capacity of the sample is defined as (Wet Weight of the paper−Dry Weight of the paper).

### Color Test Method:

An IT8 color standard for scanners (Eastman Kodak Company, Rochester, N.Y.) is placed printed side down, facing the scanner light of the scanning surface of a Scanmaker 9800 XL scanner (Microtek, Carson, Calif.) attached to any compatible computer system. The 9800 XL Scanner is run with neutral scan settings, and with color management, black-and-white points, and tonal adjustment turned off. The scanned image is acquired in the Adobe Photoshop CS2 (Adobe, San Jose, Calif.) and saved as a *.tif file. The *.tif file is opened in the Profile Maker Measure Tool Program (Gretag Macbeth/X-rite, Grand Rapids, Mich.) software program. In Profile Maker, the RGB data collected from the scanner may be correlated to known L*a*b* data (which is known from the IT8 standard) to provide a standard ICC profile.

Color-containing surfaces are tested in a dry state. Reflectance color is measured using the Hunter Lab LabScan XE reflectance spectrophotometer obtained from Hunter Associates Laboratory of Reston, Va. The spectrophotometer is set to the CIELab color scale and with a D50 illumination. The Observer is set at 10° and the Mode is set at 45/0°. Area View is set to 0.125″ and Port Size is set to 0.20″ for films; Area View is set to 1.00″ and Port Size is set to 1.20″ other materials. The spectrophotometer is calibrated prior to sample analysis utilizing the black and white reference tiles supplied from the vendor with the instrument. Calibration is done according to the manufacturer's instructions as set forth in LabScan XE User's Manual, Manual Version 1.1, August 2001, A60-1010-862.

If cleaning is required of the reference tiles or samples, only tissues that do not contain embossing, lotion, or brighteners should be used (e.g., Puffs® tissue). Any sample point on the externally visible surface of the sample containing the imparted color to be analyzed should be selected. Sample points are selected so as to be close in perceived color. A single ply of the sample is placed over the spectrophotometer's sample port. A single ply, as used within the test method, means that the externally visible surface of the sample is not folded. Thus, a single ply of an externally visible surface may include the sampling of a laminate, which itself is comprised of more than one lamina. The sample point comprising the color to be analyzed must be larger than the sample port to ensure accurate measurements. A white tile, as supplied by the manufacturer, is placed behind the externally visible surface. The L*, a*, and b* values are read and recorded. The externally visible surface is removed and repositioned so that a minimum of six readings are obtained for the externally visible surface. If possible (e.g., the size of the imparted color on the sample in question does not limit the ability to have six discretely different, non-overlapping sample points), each of the readings is to be performed at a substantially different region on the externally visible surface so that no two sample points overlap. If the size of the imparted color region requires overlapping of sample points, only six samples should be taken with the sample points selected to minimize overlap between any two sample points. The readings are averaged to yield the reported L*, a*, and b* values for a specified color on an externally visible surface of a sample.

### Color Intensity Test Method

The color intensity of a certain color of ink on a web material is determined using a densitometer which measures the color density of an ink color present on a web material. The color density values are referred to herein as the color intensity of an ink color present on a web material. Color density, a dimensionless measurement, refers to the density of the color produced by the ink. The higher the color density, the greater the intensity or strength of the color. As color density increases, the densitometer measurements also increase.

The color density of ink present on a web material is measured using a reflectance densitometer (X-RITE® 418 Reflectance Densitometer commercially available from X-Rite Inc. of Grand Rapids, Mich.). The densitometer setting is adjusted to read the ink color to be measured that is present in a print image on the web material. The sample to be measured is placed on top of four unprinted sheets of the tissue paper. The four unprinted sheets are used in order to eliminate any influence of background from a colored surface. Four sheets of a white substrate having a L*a*b* values of about 91.17, 0.64, and 4.29, respectively, wherein the L*a*b* values are measured as described above.

From the L*a*b* values, a dimensionless difference is obtained by subtracting the L*a*b* values of the unprinted background from the average L*a*b* measurement found in the indicia. The greater this difference, the greater the color density provided by the ink.

Three color density measurements are made within a given color of ink in a printed image using the reflectance densitometer. The average of the three measurements is recorded.

### Rub-Off Test Method

As used herein, “Rub-Off” refers to the transfer of color from a printed image present on a surface of a web material to another surface. Rub-Off is composed of two components, bleed and abrasion. Bleed refers to the tendency of color to leach out of a printed image on a web material upon exposure of the printed image to a liquid. Abrasion refers to the ability to remove ink from a printed image on a web material by mechanically scuffing the ink from the surface of the web material.

Rub-Off is measured using a Sutherland® Ink Rub Tester (commercially available from Danilee Co. of San Antonio, Tex.) and an X-RITE® Spectrocolorimeter (commercially available from X-Rite Inc. of Grand Rapids, Mich.). Both instruments are calibrated, cleaned and prepared according to their manufacturer's instructions.

Cut double-sided tape (0.15 caliper, gray, 3M stickyback tape commercially available from 3M Corporation of St. Paul, Minn.) into five 1.2 cm×0.9 cm rectangles for each web material sample to be tested. Select the inked area of the web material to be tested. Select inked areas where the color is printed evenly throughout the printed image. Do not test areas that have blank spots, noticeable splotches and/or discolorations. If the web material is a multi-ply product, such as a multi-ply sanitary tissue product, remove and discard any non-inked plies prior to attaching the stickyback tape as described below.

For each sample to be tested, attach the five pre-cut rectangles of tape from above to five areas on the side of the web material not being tested. With scissors, cut out each rectangle, leaving no overhang of the web material. This gives 5 replicates per color per sample.

Select a tile (white formica #458 matt finish, horizontal grade 10 tile attached to tempered hardboard (Duron Corporation) cut to 10.15 cm×10.15 cm×0.5 cm commercially available from Cabinet Suppliers of Ohio of Cincinnati, Ohio.) Clean the tile with distilled water and a lint-free towel and dry with another lint-free towel. Place the tile on the Sutherland® Ink Rub Tester's base and slide it up against the pins that are directly below the motor. Tighten the tile holder adjustment screw to hold the tile securely in place.

Attach the prepared rectangles having the color to the ends of the 5 weight splines (998.8 g splines commercially available from McMaster Can with nylon foot (1.2 cm×0.9 cm) attached).

Dispense 25 μl of the desired solution (distilled water or standard solution) onto the tile through the weight spline holder on the Sutherland® Ink Rub Tester. The standard solution is prepared as follows:

Tetra sodium EDTA 2.0 g, 100% powder from EM; Sodium carbonate 1.0 g, 100% powder from EM; distilled water 940 g total; C₁₂-C₁₄ AO Barlox 12 8.6 g, 30% solution from Lonza; 2-Butoxyethanol 47.5 g, 99% solution from Aldrich; Neodol 91-6 1.0 g, 100% solution from Shell; sodium hydroxide 12N from J. T. Baker. Place 1.0 g of Neodol into a 75-100° C. oven for approximately 20 minutes until no longer cloudy. Meanwhile, combine 2.0 g tetra sodium EDTA, 1.0 g sodium bicarbonate, and 500 g of distilled water and stir until solids are completely dissolved. After it is stirred, add the 8.6 g C₁₂-C₁₄ AO Barlox 12, 47.5 g Butoxyethanol, 440 g distilled water, and the 1.0 g Neodol, stirring after each addition. Check the pH of the solution. Add sodium hydroxide as necessary to bring the pH to 12.5. Put the standard solution into a plastic container which has a pipette lit. Fill the air space above the solution in the container with nitrogen and tightly close the lid.

Insert the weight spline into the holder with the taped sample assemblage going in first. Slowly lower the spline onto the tile ensuring the middle of the sample is going to land directly on top of the drop of solution. Use caution not to splatter the solution by dropping the weight spline. Immediately start the Sutherland® Ink Rub Tester to begin the preset cycle of 7 rubs.

Upon completion, remove the weight spline. Loosen the tile and reposition it by moving it away from the motor. Move the tile approximately 1 inch. It should not be moved so far that the left side of the tile is no longer supported by the metal pins. Tighten and repeat the rubbing procedure on this new area of the tile.

After the second rub is completed, slide the tile out, rotate it 180° and slide it back in until it reaches the stop pins. Repeat the rubbing procedure to produce to more rubs on this side of the tile. When these rubs are finished, slide the tile out and rotate it 90°. Slide the tile back until it reaches the stop pins. Produce one rub in this area.

This procedure should produce five rubs per sample, per color, per tile. Allow the tile to dry overnight in a conditioned room at a temperature of 73° F.±4° F. (about 23° C.±2.2° C.) and a relative humidity of 50%±10%.

For reading the test tiles on the X-RITE® Spectrocolorimeter, tape tile placement paper (paper with 20 horizontal lines spaced 7.5 mm apart. The total dimensions of the paper are approximately 15.24 cm×21.59 cm, with each of the horizontal lines being drawn in the 15.24 cm direction.) to a flat surface, keeping the lines horizontal in relation to the operator. Place an extra white formica #458 tile on the far right edge of the paper and tape it down also. Set the X-RITE® Spectrocolorimeter's illuminate to A10 and the function to A. E. Place the back of the spectrocolorimeter on top of the extra tile with the aperture positioned on the top of the test tile. This is so the spectrocolorimeter is flat, not at an angle, while reading the test tile. Set the averaging of the spectrocolorimeter to 1. Read 5 white areas of the test tile (2 corners and 3 down the center) and record these numbers as the background readings. Set the averaging of the spectrocolorimeter to take 8 readings. With the spectrocolorimeter, measure each rub on the test tile in 8 areas, down the middle of the rub. Do this by placing the circular window of the spectrocolorimeter base at the distal end of a rub and placing the proximal edge of the tile on one of the horizontal lines. After pressing down on the spectrocolorimeter and completing an individual read, move the tile forward (away from the operator) until the proximate edge is lined up on the next horizontal line. Repeat this sequence until all 8 reads have been stored in the spectrocolorimeter for each individual rub.

The spectrocolorimeter will calculate and display the average of the 8 readings. Record this AE value.

Repeat these steps until all 5 rubs have been evaluated.

Average the AE values of the 5 rubs or replicates on a tile to get the average color transfer for the sample. Report the average of the 5 AE values to the nearest 0.01.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for making a web material, the method comprising the steps of:
providing a web material;
feeding the web material onto an impression cylinder of a printing machine;
advancing the web material through at least four print units disposed about an outer surface of the impression cylinder, wherein each of the at least four of print units comprises a different color ink, and wherein one of the at least four print units comprises a brown ink; and
applying a plurality of ink dots consisting of the brown ink to the web material, wherein the brown ink comprises a combination of two or more pigments.

2. The method according to claim 1, further comprising the step of passing the web material through a flexographic printing process.

3. The method according to claim 1, wherein the plurality of ink dots have a circular shape.

4. The method according to claim 1, wherein the brown ink exhibits an L*a*b value of from 30, 8, 14 to 64, 15, 21.

5. The method according to claim 1, wherein the brown ink exhibits an L*a*b* of 44.82, 10.86, 18.18.

6. The method according to claim 1, wherein the brown ink exhibits an L*a*b* of 32, 9, 15 to 62, 14, 21.

7. The method according to claim 1, wherein the brown ink exhibits an L*a*b* of 42.57, 11.54, 18.03.

8. The method according to claim 1, wherein the brown ink exhibits an L*a*b* of 48, 10, 21 to 78, 15.50, 28.

9. The method according to claim 1, wherein the brown ink exhibits an L*a*b* of 58.07, 12.57, 24.98.

10. The method according to claim 1, wherein the brown ink exhibits an L*a*b* of 48, 17, 37.

11. The method according to claim 1, wherein the brown ink exhibits a hue of from about 55 to about 85.

12. The method according to claim 1, wherein the brown ink exhibits an intensity of greater than 0.27 as measured according to the Intensity Test Method.

13. The method according to claim 1, wherein the web material comprises a print image comprising the brown ink.

14. The method according to claim 13, wherein the print image further comprises at least one non-brown ink.

15. The method according to claim 1, wherein the brown ink exhibits a Rub-Off Value using a standard solution of less than 9 as measured according to the Rub-Off Test Method.

16. The method according to claim 1, wherein the brown ink exhibits a Rub-Off Value using distilled water of less than 11 as measured according to the Rub-Off Test Method.

17. The method according to claim 1, wherein the web material comprises a napkin.

18. The method according to claim 1, wherein the web material comprises a sanitary tissue product.

19. A method for making a web material, the method comprising the steps of:
providing a web material;
feeding the web material onto an impression cylinder of a printing machine;
advancing the web material through at least four print units disposed about an outer surface of the impression cylinder, wherein each of the at least four of print units comprises a different color ink, and wherein a first print unit comprises a brown ink, a second print unit comprises yellow ink, a third print unit comprises cyan ink, and a fourth print unit comprises magenta ink;
applying a plurality of ink dots consisting of the brown ink to the web material, wherein the brown ink comprises a combination of two or more pigments; and
applying a plurality of ink dots comprising at least one of yellow ink, cyan ink, and magenta ink to the web material.

20. A method for making a sanitary tissue product, the method comprising the steps of:
providing a sanitary tissue product;
feeding the sanitary tissue product into a printing machine;
advancing the sanitary tissue product through at least four print units disposed about an outer surface of an impression cylinder of the printing machine, wherein each of the at least four of print units comprises a different color ink, and wherein a first print unit comprises a brown ink, a second print unit comprises yellow ink, a third print unit comprises cyan ink, and a fourth print unit comprises magenta ink;
applying a plurality of ink dots consisting of the brown ink to the sanitary tissue product, wherein the brown ink comprises a combination of two or more pigments; and
applying a plurality of ink dots comprising at least one of yellow ink, cyan ink, and magenta ink to the sanitary tissue product.
